(19) United States
(12) Patent Application Publication
(10) Pub. No.: US 2024/0326148 A1
(43) Pub. Date: Oct. 3, 2024

(54) APPARATUS AND METHOD FOR WETTING A COMPONENT WITH A FLUX

(71) Applicant: Siemens Healthineers AG, Forchheim (DE)

(72) Inventor: Harald Geyer, Bubenreuth (DE)

(21) Appl. No.: 18/616,505

(22) Filed: Mar. 26, 2024

(30) Foreign Application Priority Data
Mar. 29, 2023 (DE) 10 2023 202 883.2

(51) Int. Cl. B23K 3/08; B23K 1/20

(52) U.S. Cl. CPC B23K 3/082; B23K 1/203

(57) ABSTRACT

An apparatus for at least partially wetting a component with a flux. The apparatus includes a flux reservoir that includes a recess that is filled with the flux. The apparatus further includes a viscosity reduction unit that is configured, when the flux reservoir is filled with flux, to reduce the viscosity of the flux at least in a localized region by excitation of the flux.

### CROSS REFERENCE TO RELATED APPLICATIONS

This application claims the benefit DE 10 2023 202 883.2 filed on Mar. 29, 2023, which is hereby incorporated by reference in its entirety.

### FIELD

Embodiments relate to an apparatus and a method for wetting a component with a flux including a flux reservoir that is filled with the flux and a viscosity reduction unit configured to reduce the viscosity of the flux at least in a localized region.

### BACKGROUND

In the field of microsystems engineering, ever higher levels of integration and thus densification and increase in signal inputs and outputs are resulting in a reduction in the pitch spacing of electronic components. Pitch spacing is taken to mean, for example in “ball-grid arrays” (BGA), the distance from one solder ball to the next. Achieving the integration density required by the increase in input and output signals in a reduced area means not only reducing pitch spacing but also solder ball sizes.

This relates to mounting and bonding technologies for detector systems, for example for X-ray imaging applications. The requirement for a higher pixel count and/or a reduction in the size thereof is accordingly likewise accompanied by an increase in output signals, so resulting in a densification of signal outputs and a smaller pitch spacing for the components to be mounted.

These electronic components, which are often what are known as “bare dies”, may be processed in what is known as a “flip chip” process. In this process, individual electronic components are provided with the side that includes the solder elements (“ball side” in the case for example of the ball grid array) facing upward on a wafer film and are rotated by way of a flipper and transferred to a gripper which grips the component (usually by vacuum) on the “unballed” side, i.e., on the side of the component that does not have solder elements. The side of the electronic component that does have solder elements is then at least partially dipped into a flux. The flux is provided in a flux cavity, into which the component, or for example its solder elements, is dipped, before it is placed for example on a substrate, for example a printed circuit board. The flux holds the component, once placed, in its placement position and during the subsequent soldering process, dissolves the oxide layers of the metallic solder element and its partner (pad).

Imperfections may, however, occur in the provided flux film. The imperfections are, for example, entrapped air/air bubbles which may have an extent of the order of magnitude of up to 100 μm.

If the component to be wetted includes solder elements of the order of magnitude of for example 250 μm, that is larger than the imperfection, it is possible to disregard such imperfections. However, the smaller the solder elements are configured, the more probable it is that interaction with imperfections in the flux film will result in non-wetting or inadequate wetting of solder elements, which may result in a failure to electrically bond or at least in a poorer quality bond in the subsequent soldering process.

### BRIEF DESCRIPTION AND SUMMARY

The scope of the present disclosure is defined solely by the claims and is not affected to any degree by the statements within this summary. The present embodiments may obviate one or more of the drawbacks or limitations in the related art. Independent of the grammatical term usage, individuals with male, female or other gender identities are included within the term.

This problem may be overcome by alternative mounting and bonding technologies such as for example conductive adhesive bonding. Another option may be to integrate redundant solder elements. Embodiments provide an improved apparatus and an improved method for wetting components with fluxes.

Embodiments provide an apparatus for at least partially wetting a component with a flux including a flux reservoir, including a recess that is filled with the flux, and a viscosity reduction unit that is configured, when the flux reservoir is filled with flux, to reduce the viscosity of the flux at least in a localized region by excitation of the flux.

The component may for example be an electronic component, for example an integrated circuit in a housing or in the form of a “bare die”. The component may be provided for an X-ray detector. The component may, for example, also include a converter element configured to convert X-rays into electrical signals. The component may for example be equipped on one side with contact elements, for example solder elements, that are intended to be electrically conductively bonded in a subsequent soldering process to a further component, for example to mating contact elements provided there.

The flux is a substance that is added during soldering processes and which brings about better wetting of the component, or its contacts, by the solder. The flux removes the oxides located on the surfaces by chemical reaction. The same applies to oxides which arise during the soldering process due to atmospheric oxygen. Fluxes moreover reduce interfacial tension.

The flux may for example be what is known as a rosin, that is a resin system that is obtainable either from trees or synthetically. This resin matrix includes embedded individual crystals of acid components (e.g., glutaric acid, acrylic acid) that, in the subsequent soldering process, serve to reduce possible oxide layers on the parts that are joined, i.e., the corresponding contact elements that are to be bonded. The acid components may be spherical or rod-shaped and are <10 μm in size. Fluxes may be processed at room temperature (approx. 20° C.).

The apparatus provides a flux reservoir with a recess, i.e., a cavity, into which the flux may be introduced. In the cavity, the flux generally assumes the form of a flux film, the height of that is determined by the dimensions of the recess. A component may be at least partially dipped into the flux film present in the recess in order to be wetted with flux. The necessary height of the flux film and thus of the recess may vary from application to application and for example depend on the component to be wetted. In variants, the flux is for example spread in the recess using a doctor blade, such that a uniform and reproducible flux height is formed in the recess.

Unless further measures are taken, however, the flux spread in the recess may, as already previously described, include imperfections, for example in the form of entrapped air or ripples produced by the spreading, that may impair wetting of the component with flux. This may be all the more serious the smaller are the dimensions of the parts of the component that are to be wetted.

Embodiments provide an apparatus for wetting a component with a flux that includes a viscosity reduction unit that is configured, when the flux reservoir is filled with flux during use of the apparatus, to reduce the viscosity and/or surface tension of the flux at least in a localized region by excitation of the flux.

Excitation may include mechanical excitation, for example mechanical force excitation, of the flux. Excitation may include thermal excitation of the flux. For example, excitation modifies the properties of the flux such that its viscosity is at least temporarily reduced at least in the localized region in which excitation takes place. The reduced viscosity raises the fluidity of the flux, such that imperfections are smoothed out. This occurs because the reduced viscosity allows the flux to flow better in the doctor bed. A reduced surface tension of the flux in the recess may for example assist the described smoothing such that near-surface imperfections may be more effectively mitigated.

Improved and for example reliable wetting of the component may be achieved by way of the apparatus. This better ensures that high-quality electrically conductive bonds are obtained in a subsequent soldering process and thus a likewise higher quality of the resultant workpieces. For example, rejects may be reduced.

According to an embodiment, the flux reservoir itself includes the viscosity reduction unit. Excitation of the flux may be brought about via the mechanical or thermal connection of the flux reservoir with the flux present in the flux reservoir.

Sufficient space may as a rule be provided in the flux reservoir for provision of the viscosity reduction unit. Connection and control of the viscosity reduction unit may likewise be made particularly straightforward. It is possible to provide simultaneous, planar excitation of the flux over the entire region of the recess if the viscosity reduction unit is configured in this manner in the flux reservoir.

According to an embodiment, the apparatus includes a doctor blade for smoothing a surface of the flux. The doctor blade, when the flux reservoir is filled with flux, is movable along a surface of the flux. The doctor blade includes the viscosity reduction unit.

A doctor blade may for example be provided such that an edge or a planar region of the doctor blade is movable in a planar manner over the surface of the flux along an upper edge of the recess of the flux reservoir. The doctor blade may be provided for the purpose of forming a reproducible flux height in the cavity when the recess is filled with flux. Such a doctor blade may be movable over the surface of the flux in the form of a linear movement, i.e., along an axis. Provision may also be made for a rotary movement of the doctor blade to be provided. An edge or a planar region of the doctor blade is moved over the surface of the flux in a rotational motion.

A provided doctor blade may include the viscosity reduction unit and, while the doctor blade is moving over the surface of the flux, excite the flux locally, for example thermally or mechanically, at least at the position of the doctor blade. In this way, the viscosity of the flux may be reduced in this region.

During wetting of the component, imperfections in the flux film for example at a surface of the flux film may be particularly disadvantageous. Excitation at a surface of the flux by the doctor blade guided thereover may reduce these in targeted manner without the entire volume of the flux being excited with the flux reservoir.

Both the flux reservoir and a provided doctor blade may include a viscosity reduction unit.

For example, a temperature of the flux may be raised by thermal excitation. This takes advantage of the temperature-dependent behavior of the flux, that becomes less viscous and thus concomitantly more fluid at elevated temperature. The increased fluidity smooths imperfections since the flux may flow better thanks to its reduced viscosity. The reduced surface tension of the flux bed assists the described smoothing, such that near-surface imperfections are mitigated. The flux moreover attains enhanced wetting characteristics thanks to this “liquefaction”.

In an embodiment, the viscosity reduction unit is configured to raise the temperature of the flux to a temperature of up to 35° C., for example of up to 50° C., at least in the localized region. A suitable reduction in viscosity may be achieved without any disadvantageous impact on the flux's properties for a soldering process.

The viscosity reduction unit may for example include a heating coil for thermal excitation of the flux. The heating coil may for example be provided in the flux reservoir. A planar arrangement below the recess for the flux may provide planar thermal excitation of the flux. A heating coil may also be provided in a provided doctor blade and for example provide thermal excitation at the position of the doctor blade.

Heating by a heating coil provides a conveniently simple implementation of thermal excitation.

A highly thermally conductive configuration of the flux reservoir at least in a region in which a thermally conductive action on the flux is to be ensured is advantageous in combination therewith. The flux reservoir, for example an enclosure for the recess, for example includes a metallic material for this purpose.

In an embodiment, the viscosity reduction unit may also include an induction coil for thermal excitation. For example, an appropriately interacting, electrically conductive enclosure for the recess may be provided in the flux reservoir, such that inductive heating of the enclosure and thereby of the flux may be achieved. The coil itself may be enclosed in a nonconductive material.

The heat supplied by way of induction is readily and quickly controllable.

In an embodiment, the viscosity reduction unit is configured to excite the flux mechanically by way of vibration.

This takes advantage of the behavior of the flux in that it may modify its viscosity properties by external force excitation, i.e., by way of vibration. For example, the viscosity of the flux present in the flux reservoir may be reduced by mechanical excitation by vibration. This may be explained by shear-thinning flow behavior and the frictional heat generated by vibration. Imperfections may advantageously be smoothed as a result since the flux may flow better thanks to its reduced viscosity. The reduced surface tension of the flux assists the described smoothing, such that for example near-surface imperfections are mitigated. Frequencies of the vibrations may for example be in a range of less than 60 kHz, for example up to 30 kHz. A static frequency may be selected or it may alternatively be varied. For example, a frequency sweep from a starting frequency to a final frequency may be used. The period of application may for example amount to less than 120 s, for example up to 60 s, such that the wetting method sequence is not excessively delayed.

To introduce vibration, the viscosity reduction unit may for example have mechanical/hydraulic or piezo-controlled actuators. Vibration may be achieved by appropriately driving the actuators.

The flux reservoir and/or a provided doctor blade may include such a viscosity reduction unit based on introducing vibration. A viscosity reduction unit arranged in the flux reservoir may produce vibration of the flux reservoir that correspondingly propagates itself via the boundary surfaces onto the flux present in the flux reservoir. This for example also provides excitation that may simultaneously be brought about in the entire volume of the flux. A viscosity reduction unit provided in the doctor blade, on the other hand, primarily provides excitation in a region around the position of the doctor blade as it moves over the surface of the flux.

The viscosity reduction unit may provide a combination of thermal and mechanical excitation.

The flux reservoir may furthermore include a base plate and a flux insert. The flux insert is detachably positionable on the base plate and the flux insert includes the recess to be filled with the flux.

A detachable combination of an insert with the recess provided for the flux and a base plate may provide straightforward exchange of the flux insert, such that different heights of flux film may be provided by differently configured flux inserts.

This may be advantageous if the flux reservoir includes the viscosity reduction unit that is provided in the base plate. In this way, different, straightforwardly providable flux inserts may be provided for exchange. Use may be made of the same base plate for advantageous excitation.

The flux insert may include a different material than the base plate. They may, however, also be manufactured from the same material. The flux insert may for example include a metal. This may for example be advantageous for thermal excitation of the flux with an appropriately configured viscosity reduction unit.

The flux insert is detachably positionable on the base plate that means that the base plate and flux insert may be separated and put back together again repeatedly and without damage.

The base plate may then include positioning mechanisms that are configured to position the flux insert relative to the base plate.

The positioning mechanisms may provide repeatedly identical and exact positioning of the flux insert on the base plate. The positioning mechanisms may moreover fix the flux insert at least along one direction, for example at least along two directions, parallel to the planar extent of the base plate. In this way, slippage of the flux insert may be prevented during movement of the flux reservoir, for example during vibration.

A simple positioning may involve the base plate including a depression adapted to the flux insert into which the flux insert may be laid.

Other positioning mechanisms may furthermore also be provided, for example pins or recesses formed on the flux insert that interact with complementary recesses and pins formed on the base plate.

Embodiments provide a method for at least partially wetting a component with a flux including the steps of: first provision of the component that is provided for at least partial wetting with the flux, second provision of an apparatus for at least partial wetting of the component with flux as claimed in one of the preceding claims, which apparatus is filled with the flux, excitation of the flux by way of the viscosity reduction unit, such that the viscosity of the flux in the apparatus is reduced at least in a localized region, at least partial dipping of the component into the flux such that the component is at least partially wetted with flux, and provision of the component at least partially wetted with flux.

The configurations that have previously been described in connection with the apparatus may also be carried out and used in the corresponding method. The description provided with regard to the apparatus and the previously described advantages may also be applied to the method. For example, mechanical and/or thermal excitation may be provided. Mechanical excitation may for example be concluded before the step of at least partial dipping is carried out.

At least partial dipping may for example involve at least partially dipping contact elements or solder elements formed on the component into the flux.

The component may for example include a converter element for an X-ray detector system configured to convert X-rays into electrical signals, or an integrated circuit for an X-ray detector system for evaluating electrical signals that arise in an X-ray imaging application on detection of X-rays, which converter element or which integrated circuit is equipped on one side with solder elements for electrical contacting. The at least partial dipping of the component involves at least partially dipping the solder elements into the flux.

Components for implementing smaller pixel sizes and/or a greater pixel count in X-ray detector systems may be better prepared for a subsequent soldering process.

Use of the indefinite article “a” or “an” does not rule out the possibility of the feature in question also being present in multiple instances. Use of the term “include” does not rule out the possibility of the terms linked by the term “include” being identical. Use of the term “unit” does not rule out the possibility of the object to which the term “unit” relates including a plurality of components that are spatially separated from one another.

### BRIEF DESCRIPTION OF THE FIGURES

FIGS. 1, 2, 3, and 4 depict schematic cross-sectional representations of an apparatus for wetting a component with a flux according to an embodiment.

FIG. 5 depicts a further cross-sectional representation of an apparatus for wetting a component with a flux in a partially disassembled form according to an embodiment.

FIG. 6 depicts an example of application of a component that has been wetted with flux by way of an apparatus or method for wetting a component with a flux according to an embodiment.

FIG. 7 depicts a method sequence for wetting a component with a flux according to an embodiment.

### DETAILED DESCRIPTION

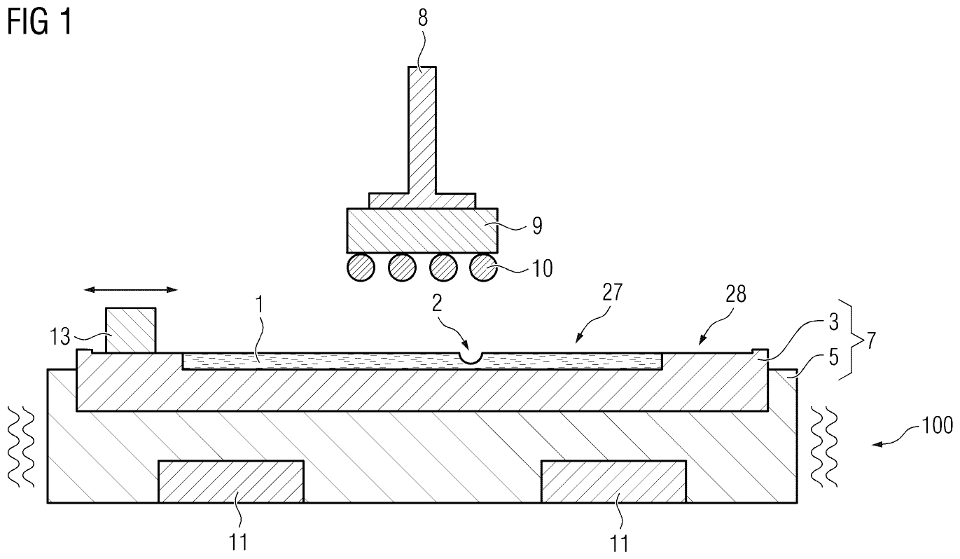

FIGS. 1, 2, 3, and 4 in each case depict a schematic cross-sectional representation of an apparatus 100 for at least partially wetting a component 9 with a flux 1 according to an embodiment.

The apparatuses 100 in each case includes a flux reservoir 7 that includes a recess 27 that may be filled with flux. In the representations, the recess 27 is in each case filled with flux 1. The flux 1 may for example be what is known as rosin. In the recess 27, the flux 1 assumes the form of a flux film, the height of which is determined by the dimensions of the recess 27. An initial viscosity of the flux may for example be between 25 and 50 Pa*s.

The flux reservoir 7 includes a base plate 5 and a flux insert 3. The flux insert 3 is detachably positionable on the base plate 5 and the flux insert 3 includes the recess to be filled with the flux 1. In certain embodiments, the flux reservoir 7 may be of one-piece construction.

A detachable combination of a flux insert 3 with the recess provided for the flux 1 and a base plate 5 may provide straightforward exchange of the flux insert 3, such that different heights of flux film may be provided by differently configured flux inserts 3.

Depending on the configuration and associated requirements, the flux insert 3 may include a different material than the base plate 5. They may, however, also be manufactured from the same material.

The flux 1 may be spread in the recess 27 for example using a doctor blade 13, such that a uniform and reproducible flux height is formed in the recess 27. In the depicted embodiments, the doctor blade 13 is linearly displaceable along an upper edge of recess 27 and is guided by or its movement space is bounded by a further recess 28 of the flux insert 3. There may, however, also be other configurations of a doctor blade. For example, a rotational motion of the doctor blade over the surface of the flux 1 may also be provided.

A component 9, that may for example be an electronic component, for example an integrated circuit, is in each case furthermore shown, which component is equipped on one side with solder elements 10 that are to be electrically conductively bonded to a further component, for example to mating contact elements provided there, in a subsequent soldering process. The component 9 is fastened to a gripper 8 that is configured to at least partially dip the component 9 into the flux 1 for at least partial wetting.

The flux 1 spread in the recess 27 may, however, include imperfections 2, for example in the form of entrapped air or air bubbles or ripples produced by the spreading, that may impair wetting of the component 9 with flux 1. In the examples depicted, if no further steps are taken, wetting of the left-hand, outer solder element 10 might prove to be only inadequate due to the imperfection 2 that is present.

In order to avoid this, the apparatuses 100 depicted in FIGS. 1, 2, 3, and 4 in each case have a viscosity reduction unit 11, 12, 15, 16, 17 that is configured, during filling of the flux reservoir 7 with flux 1, to reduce the viscosity of the flux 1 in at least one localized region by excitation of the flux 1 that is present.

The flux reservoir 7 or doctor blade 13 or both may include such a viscosity reduction unit 11, 12, 15, 16, 17.

The excitation may include mechanical excitation, for example a mechanical force excitation, and/or thermal excitation of the flux 1. The excitation for example leads to a modification of the properties of the flux 1 such that its viscosity is at least temporarily reduced at least in the localized region in which excitation takes place, such that the fluidity of the flux 1 is raised and imperfections 2 are smoothed. A reduced surface tension of the flux 1 in the recess may for example assist the described smoothing such that near-surface imperfections 2 are more effectively mitigated.

FIG. 1 depicts an example where the flux reservoir 7, for example the base plate 5 thereof, includes the viscosity reduction unit 11.

The viscosity reduction unit 11 is configured to mechanically excite the flux 1 by way of vibration. The viscosity reduction unit 11 includes hydraulic and/or piezo-controlled actuators that, when driven, produce a vibrational movement of the flux reservoir 7. This movement is transferred via the boundaries of the recess 27 to the flux 1, whereby a reduction in viscosity is achieved and any imperfections in the flux film 1 are concomitantly smoothed.

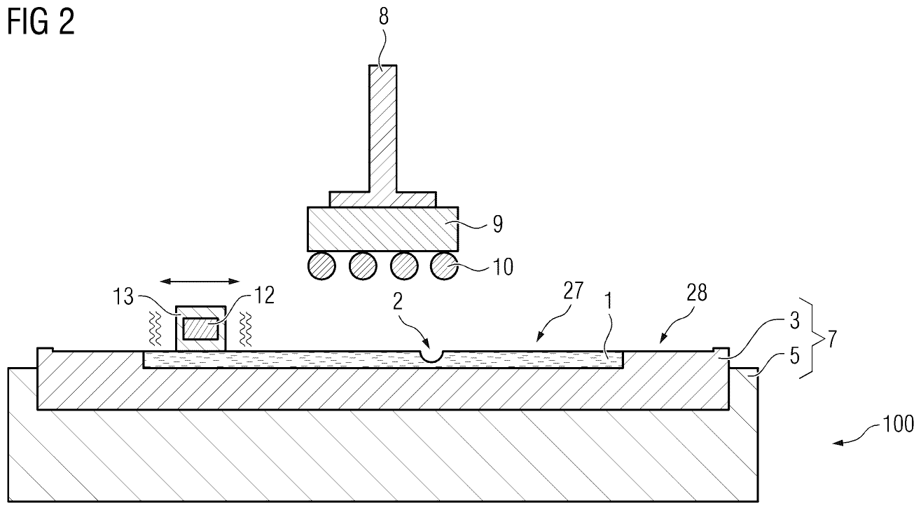

FIG. 2, in contrast, depicts the arrangement of the viscosity reduction unit 11 in the doctor blade 13 that, when the flux reservoir 7 is filled, is movable along a surface of the flux 1 and along the upper edge of the recess 27.

The viscosity reduction unit 12 includes hydraulic and/or piezo-controlled actuators that, when driven, produce a vibrational movement of the doctor blade 13. When the doctor blade 13 is moved over the surface of the flux 1, the flux 1 is locally mechanically excited at least at the position of the doctor blade 13 by the vibration of the doctor blade 13 and a reduction in viscosity is brought about.

Vibration according to one of the previously described embodiments may for example have a frequency in a range of more than 0 Hz and less than 60 kHz, for example less than 30 kHz. A static frequency may be selected or it may alternatively be varied. The period of application may here for example be less than 120 s, for example less than 60 s.

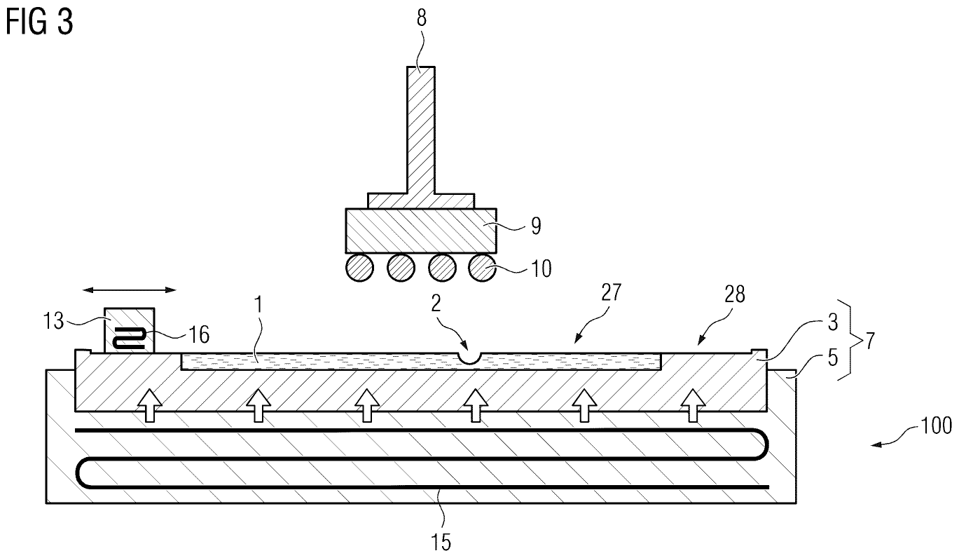

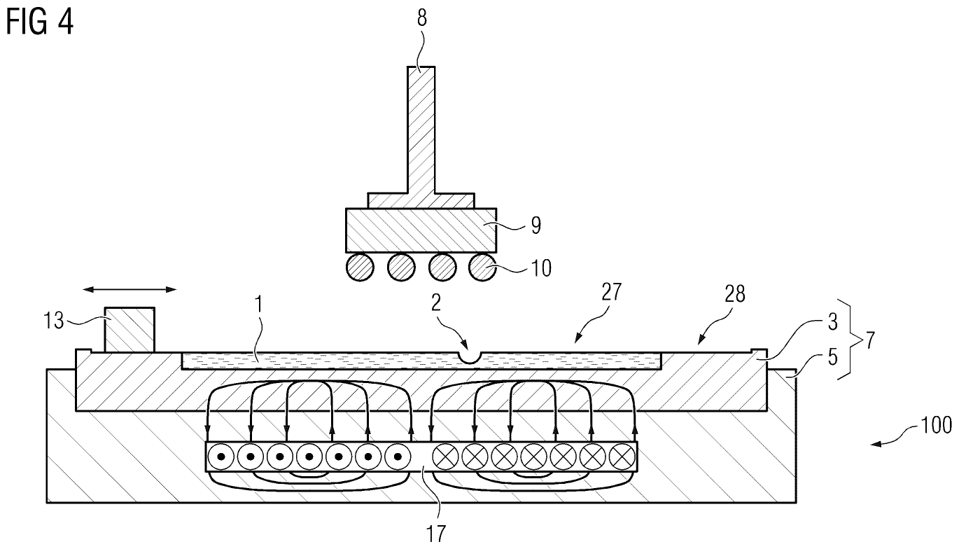

FIGS. 3 and 4 depict the possibility of thermal excitation of flux 1, whereby the temperature of the flux 1 is raised.

In an embodiment, the viscosity reduction unit 15, 16, 17 is configured to raise the temperature of the flux 1 to a temperature of up to 35° C., for example of up to 50° C., at least in a localized region.

FIG. 3 depicts an embodiment where the viscosity reduction unit 15, 16 includes a heating coil for thermal excitation of the flux. A heating coil is arranged both in the flux reservoir 7 and in the doctor blade 13. One or more heating coils may, however, also be provided only in the flux reservoir 7 or only in the doctor blade 13.

When the heating coil is arranged in the flux reservoir 7, it is advantageous for this to be combined with a readily thermally conductive configuration of the flux reservoir 13 at least in a region in which a thermally conductive action from the heating coil to the flux 1 is to be ensured. The flux reservoir 7, for example an enclosure of the recess 27, for example includes a metallic material for this purpose.

FIG. 4 depicts an embodiment for thermal excitation using an induction coil 17. The flux insert 3 is formed from an electrically conductive material that may be induction-heated by the induction coil 17. The coil itself may be enclosed in a nonconductive material of the base plate.

There may be still additional embodiments other than those shown. Accordingly, a combination of thermal and mechanical excitation may, for example, also be implemented.

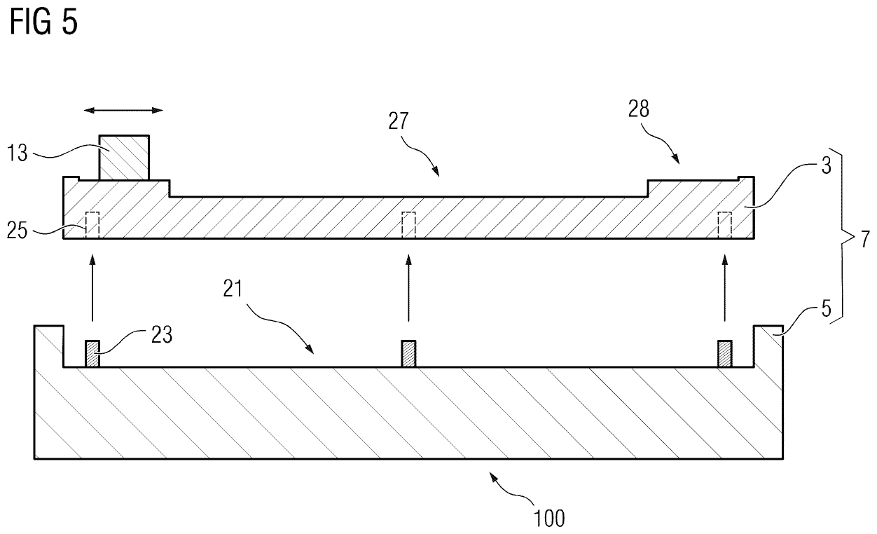

FIG. 5 depicts an apparatus 100, as may be provided in the above-described examples, where the base plate 5 and the flux insert 3 are depicted in a separated state. The viscosity reduction unit 11, 12, 15, 16, 17 is no longer explicitly depicted.

The flux insert 3 is detachably positionable on the base plate 5. The base plate 5 includes positioning mechanisms 21, 23 for advantageous positioning of the flux insert 3 on the base plate 5.

The depression 21 may act as a positioning mechanisms in the base plate 5. The recess 21 is adapted to the flux insert 3 that may be laid with an exact fit into the recess 21.

Optional recesses, i.e., holes, 25 are furthermore formed in the flux insert 3, which recesses may interact with complementary pins 23 formed on the base plate 5 and contribute to more stable positioning.

The positioning mechanisms 21, 23, 25 may provide repeatedly identical and exact positioning of the flux insert 3 on the base plate 5. The positioning mechanisms 21, 23, 25 may moreover fix the flux insert 3 parallel to the planar extent of the base plate 5. In this way, slippage of the flux insert 3 may be avoided during movement of the flux reservoir 7, for example during vibration. In addition to the positioning mechanisms 21, 23, 25 shown here, there may also be further or differently formed positioning mechanisms. For example, it is also possible to provide such positioning mechanisms that are configured to prevent unintended movement perpendicular to the planar extent of the base plate 5.

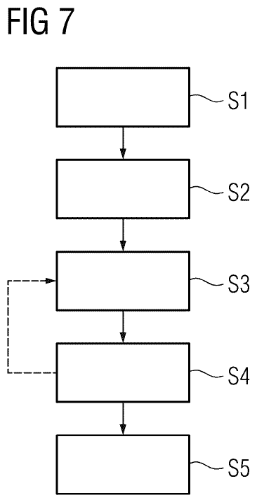

FIG. 7 depicts a method sequence for at least partially wetting a component 9 with a flux 1.

The method includes the steps of first provision S1 of the component 9, that is provided for at least partial wetting with the flux 1, and second provision S2 of an apparatus 100 for at least partially wetting the component 9 with flux 1 according to one of the previously described variants, which apparatus is filled with the flux 1.

The method further includes excitation S3 of the flux 1 by way of the viscosity reduction unit 11, 12, 15, 16, 17, such that the viscosity of the flux 1 in the apparatus 100 is reduced at least in a localized region 7.

Excitation S3 may here include thermal excitation, for example by heating the flux 1, and/or mechanical excitation, for example by vibration.

The step of at least partial dipping S4 of the component 9 in the flux 1 then proceeds, such that the component 9 is at least partially wetted with flux 1, whereupon, in the provision step S5, the component 9 at least partially wetted with flux 1 is provided.

The at least partial dipping S4 may for example include at least partially dipping contact elements 10 formed on the component 9 into the flux 1, such that the elements are at least partially wetted.

Repeated excitation S3 and dipping S4 may be performed, for example with another positioning of the component 9, before the component 9 is provided in step S5.

In one specific application, the component 9 may for example be a converter element 43 for an X-ray detector system configured to convert X-rays into electrical signals, or an integrated circuit 42 for an X-ray detector system, which converter element or which integrated circuit is equipped on an underside with solder elements 10 for electrical contacting. The at least partial dipping S4 of the component 9 involves at least partially dipping the solder elements 10 into the flux 1.

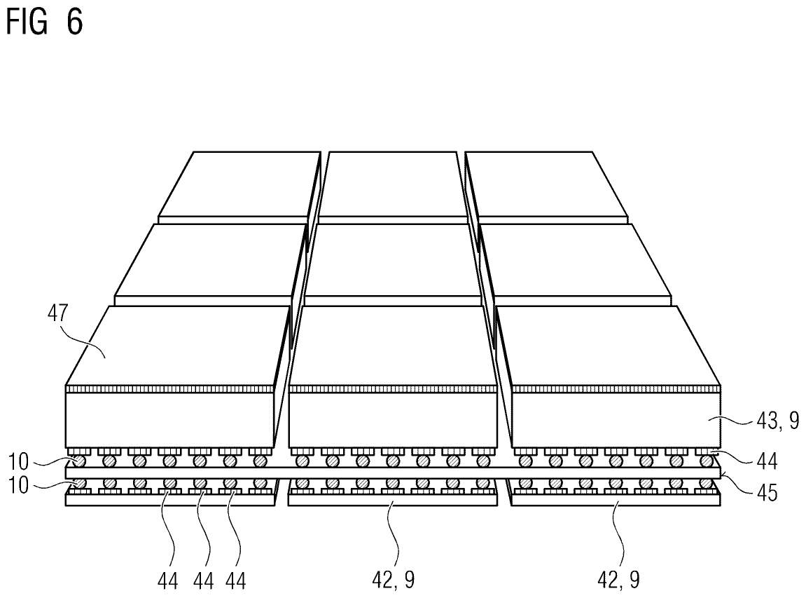

FIG. 6 depicts by way of example a stacked structure for an X-ray detector system including a plurality of converter elements 43 that are arranged adjacent one another in a sensor plane. A respective converter element 43 may take the form of a flat panel direct converter, for example having CdTe, CZT, CdZnTeSe, CdTeSe, CdMnTe, InP, TIBr2, HgI2, GaAs or Si. The top of the converter element 3 includes a first electrode 48 (top electrode). The bottom of the converter element 43 includes sensor pixel electrodes 44, wherein, during operation of the X-ray detector system, a voltage is applied between the electrode 48 and the sensor pixel electrodes 44.

In the example shown, the sensor pixel electrodes 44 are by way of example electrically conductively bonded via a rewiring layer 45 to in each case associated contacts 44 on the evaluation units 42. A respective evaluation unit 42 may, for example, include an ASIC (“application-specific integrated circuit”). The evaluation units 42 are configured to acquire, digitize and optionally further process the electrical signals that are generated in the converter unit 43 in response to incident X-rays.

Both the converter elements 43 and the evaluation units 42 are electrically conductively bonded to the rewiring layer 45 via so-called solder balls 10 (“bump bonds”). Before the bonding soldering process of an evaluation unit 42 or a converter element 43 to the rewiring layer 45 or contact elements formed thereon, both a respective evaluation unit 42 and a respective converter element 43, that are equipped on one side with the shown solder elements 10, may advantageously be wetted with flux 1 by way of a previously described apparatus or by way of the previously described method as the component 9 stated therein, such that the respective solder elements 10 are at least partially wetted with the flux 1.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that the dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. An apparatus for at least partially wetting a component with a flux, the apparatus comprising:
a flux reservoir including a recess filled with the flux; and
a viscosity reduction unit configured to reduce a viscosity of the flux in the flux reservoir at least in a localized region by excitation of the flux.

2. The apparatus of claim 1, wherein the flux reservoir comprises the viscosity reduction unit.

3. The apparatus of claim 1, further comprising:
a doctor blade that is movable along a surface of the flux in the flux reservoir, wherein the doctor blade comprises the viscosity reduction unit.

4. The apparatus of claim 1, wherein the viscosity reduction unit is configured to increase a temperature of the flux by thermal excitation.

5. The apparatus of claim 4, wherein the temperature is raised to at most 50° C.

6. The apparatus of claim 1, wherein the viscosity reduction unit comprises a heating coil.

7. The apparatus of claim 1, wherein the viscosity reduction unit includes an induction coil.

8. The apparatus of claim 1, wherein the viscosity reduction unit is configured to mechanically excite the flux by way of vibration.

9. The apparatus of claim 8, wherein the viscosity reduction unit includes hydraulic or piezo-controlled actuators.

10. The apparatus of claim 1, wherein the flux reservoir includes a base plate and a flux insert, wherein the flux insert is detachably positionable on the base plate and the flux insert includes the recess to be filled with the flux.

11. The apparatus of claim 10, wherein the viscosity reduction unit is formed in the base plate.

12. The apparatus of claim 10, wherein the flux insert comprises a metal.

13. The apparatus of claim 10, wherein the base plate includes positioning mechanisms that are configured to position the flux insert relative to the base plate.

14. A method for at least partially wetting a component with a flux, the method comprising:
providing a component for at least partial wetting with the flux;
providing an apparatus for at least partially wetting the component with flux, the apparatus comprising a flux reservoir including a recess filled with the flux and a viscosity reduction unit configured to reduce a viscosity of the flux in the flux reservoir at least in a localized region by excitation of the flux;
exciting, by the viscosity reduction unit, of the flux such that the viscosity of the flux in the apparatus s reduced at least in the localized region;
at least partial dipping, the component in the flux such that the component is at least partially wetted with flux; and
providing the component at least partially wetted with flux.

15. The method of claim 14, wherein the component comprises a converter element for an X-ray detector system configured to convert X-rays into electrical signals, or an integrated circuit for an X-ray detector system, which converter element or which integrated circuit is equipped on one side with solder elements for electrical contacting, and wherein at least partial dipping of the component involves at least partially dipping the solder elements into the flux.
